(19) United States
(12) Patent Application Publication
(10) Pub. No.: US 2008/0305375 A1
(43) Pub. Date: Dec. 11, 2008

(54) Primary Zinc Air Battery and Primary Zinc Air Cell Thereof

(76) Inventors: De-Qian Yang, City of Industry, CA (US); Yu-Qiang Yang, City of Industry, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/760,932

(22) Filed: Jun. 11, 2007

(51) Int. Cl. H01M 12/06

(52) U.S. Cl. 429/27

(57) ABSTRACT

A primary zinc air battery includes a case, an air inlet, an air outlet, a plurality of primary zinc air cells, an electric socket and a fan. Both the air inlet and the air outlet are disposed on the case. The primary zinc air cells are disposed in the case and are electrically connected to each other. The electric socket is disposed on the case and is electrically connected to the primary zinc air cells. The fan is disposed in the case.

### BACKGROUND

1. Field of Invention

The present invention relates to an electrical current producing apparatus. More particularly, the present invention relates to an electrical current producing apparatus having zinc and air as a components thereof.

2. Description of Related Art

Miniature primary zinc air button cells have gained significant popularity in hearing aid for many decades already. These primary zinc air button cells usually discharge at very low current. U.S. Pat. No. 4,118,544 taught the use of restricted gas passage to have longer service time at μA grade. U.S. Pat. No. 4,189,526 taught the use of an oxygen diffusivity-limiting membrane to have the longer service time at μA grade, too.

The rapid increasing of demands of the portable electronic appliances and tactical power source for warriors leads to the development of the large capacity and high power batteries necessary. The most commonly used military primary battery is the lithium sulfur dioxide battery BA-5590/U; it is far short of both capacity and power of the coming demands. Besides, the toxic gas released from this kind of battery may hurt the users. The popularization of the 3G-system mobile phone needs large capacity and high power battery too. So, there is a huge market ready for the large capacity and high power primary zinc air battery; it is an environmental-friendly battery and no toxic gas releasing.

The enlargement of the miniature zinc air button cell to larger cell is restricted by many factors. As the hydrogen evolution is unavoidable during storage, the sealing line of the cell has to endure more force created by internal pressure established by hydrogen; hence, the larger the cell, the easier the leak of electrolyte. Although the U.S. Pat. No. 6,265,102 taught a clamping method, but it is still not effective while the size of the primary zinc air cell is further enlarged. To have more energy capacity, the large cell may be rectangular shape; but the rectangular shape is much difficult to seal than the round shape. To have higher power, the cell has to have larger area of air cathode; but it is not only expensive, but also lowers the specific energy within a limiting space.

### SUMMARY

According to one embodiment of the present invention, a primary zinc air battery includes a case, an air inlet, an air outlet, a plurality of primary zinc air cells, an electric socket and a fan. Both the air inlet and the air outlet are disposed on the case. The primary zinc air cells are disposed in the case and are electrically connected to each other. The electric socket is disposed on the case and is electrically connected to the primary zinc air cells. The fan is disposed in the case.

According to another embodiment of the present invention, a primary zinc air cell includes a cover, a tray, a lip, a sealing member, a separator, a zinc paste, an air cathode, a blocking layer, a gasket and a piece of liquid-absorb paper. The cover has a plurality of air inlet holes disposed thereon. The tray is coupled with the cover. The lip extends outwards from the wall of the tray. The sealing member is sandwiched between the cover and the tray. The separator is positioned between the cover and the tray for forming a cavity between the separator and the tray. The zinc paste is filled with the cavity. The air cathode is positioned between the separator and the cover. The blocking layer is positioned between the air cathode and the cover. The gasket is positioned between the periphery of the blocking layer and the cover. The piece of liquid-absorb paper is less than the size of the air cathode and positioned between the blocking layer and the cover.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a perspective view of a primary zinc air battery according to one embodiment of the present invention.

FIG. 2 shows the inside arrangement of the primary zinc air battery shown in FIG. 1.

FIG. 3 is an equivalent circuit diagram illustrating how the primary zinc air cells of FIG. 1 are electrically connected to each other.

FIG. 4 is an equivalent circuit diagram illustrating how the primary zinc air cells are electrically connected to each other according to another embodiment.

FIGS. 5A-5C shows how the electric socket of FIG. 1 is electrically connected to electric plugs on the electronic equipments.

FIG. 6 is a perspective view showing one of the primary zinc air cells shown in FIG. 2.

FIG. 7 is a partial sectional view along line A-A shown in FIG. 6.

FIG. 8 is an exploded view of the primary zinc air cell shown in FIG. 6.

FIGS. 9A and 9B are sectional views of the cover shown in FIG. 8 before and after installation.

FIG. 10 is a bottom view of the tray shown in FIG. 8.

FIG. 11 is a sectional view along line B-B shown in FIG. 10.

FIG. 12 is a sectional view of the sealing member shown in FIG. 8.

FIG. 13 is a perspective view of a primary zinc air cell according to another embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

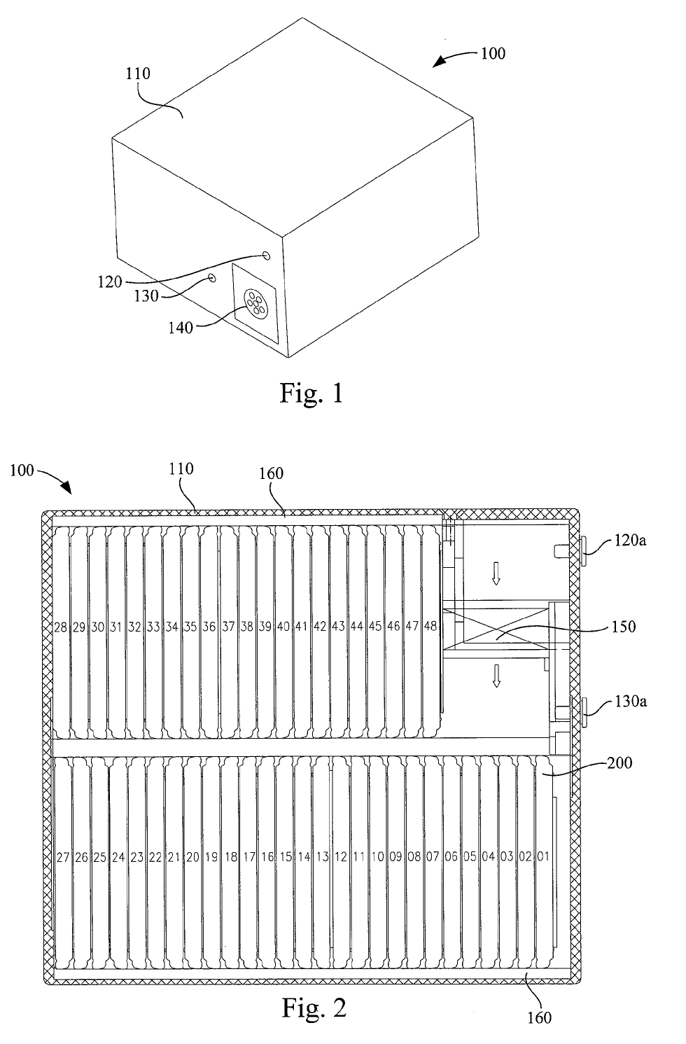

Reference is made to FIG. 1. FIG. 1 is a perspective view of a primary zinc air battery according to one embodiment of the present invention. The primary zinc air battery 100 includes a case 110, an air inlet 120, an air outlet 130 and an electric socket 140. Both the air inlet 120 and the air outlet 130 are disposed on the case 110. Furthermore, the electric socket 140 is disposed on the case 110 as well.

Reference is made to FIG. 2. FIG. 2 shows the inside arrangement of the primary zinc air battery 100 shown in FIG. 1. There may be a plurality of primary zinc air cells 200 and a fan 150 disposed in the case 110. The primary zinc air cells 200 are electrically connected to each other. In addition, the electric socket 140 (shown in FIG. 1) is electrically connected to the primary zinc air cells 200.

In order to extend the shelf life without complicated packaging, there are two soft plastic plugs 120a and 130a are inserted into the air inlet 120 and the air outlet 130 (shown in FIG. 1) on the case 110 to prevent air going to inside of the zinc air battery 100. The soft plastic plugs 120a and 130a can be made of any elastomer, such as butyl rubber. The electric socket 140 is not an absolutely sealed part; so that air cannot enter the case 110 through the electric socket 140, because there is always little positive pressure created by hydrogen evolved due to self-discharge, but any hydrogen evolved due to self-discharge will leak to atmosphere through the electric socket 140.

The primary zinc air battery 100 shown in FIG. 2 may further include at least one sheet of liquid-absorb paper 160 disposed on the inner surface of the case 110. This liquid-absorb paper 160 can prevent the electrolyte from leaking out the case 110 after discharge.

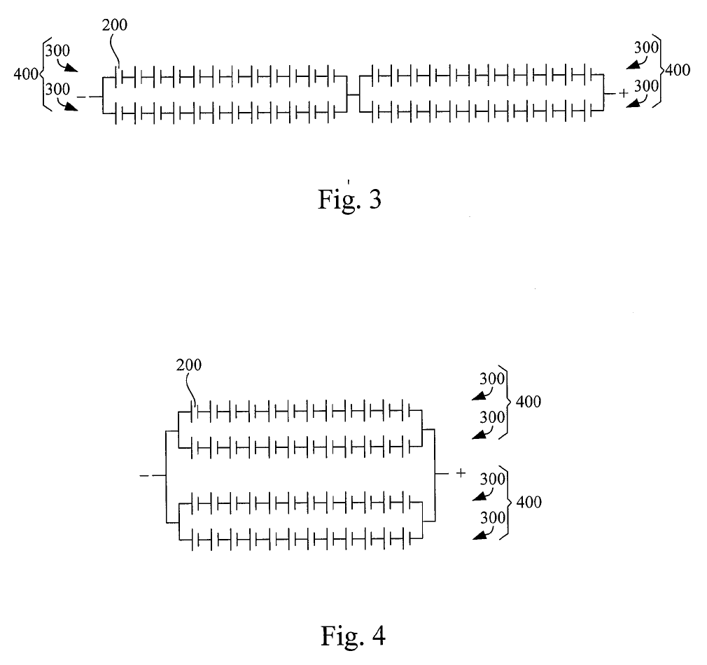

Reference is made to FIG. 3. FIG. 3 is an equivalent circuit diagram illustrating how the primary zinc air cells 200 of FIG. 2 are electrically connected to each other. As shown in FIG. 3, the primary zinc air cells 200 may be divided into at least two cell sections 400, and the cell sections 400 are electrically connected to each other in series. Each of the cell sections 400 may be divided into at least two cell sub-groups 300, and the cell sub-groups 300 are electrically connected to each other in parallel. Particularly, each of the cell sub-groups 300 has parts of the primary zinc air cells 200, for example twelve pieces of the primary zinc air cells 200, electrically connected to each other in series.

Therefore, the primary zinc air battery has the ability to supply 28V direct current (DC) when each of the primary zinc air cells provides nominal voltage of 1.17V DC. In another embodiment, the cell sections 400 (shown in FIG. 4) may be electrically connected to each other in parallel to provide 14V DC.

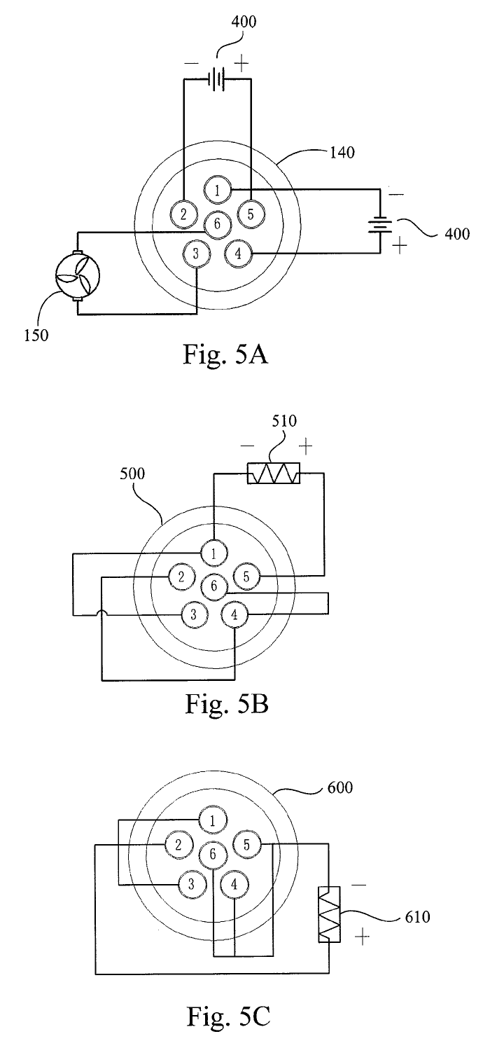

Reference is made to FIGS. 5A-5B. FIGS. 5A-5B shows how the electric socket 140 of FIG. 1 is electrically connected to an external load 510 through an electric plug 500 at the 28V nominal voltage mode. In FIG. 5A, the electric socket 140 is a SC-C-179492 socket with six receptors specified in the MIL-PRF-49471(CR) military specification. One cell section 400 electrically connects the receptors No. 1 and No. 4 of the electric socket 140, and another cell section 400 electrically connects the receptors No. 2 and No. 5 of the electric socket 140. In FIG. 5B, the electric plug 500 with six pins to match the electric socket 140 (shown in FIG. 5A) is provided. The external load 510 electrically connects the pins No. 1 and No. 5 of the electric plug 500, while the other pins are electrically connected as shown in FIG. 5B. Therefore, the two cell sections 400 can be electrically connected in series to supply 28V nominal voltage, when the electric plug 500 is inserted into the electric socket 140.

Reference is made to FIGS. 5A and 5C. FIGS. 5A and 5C shows how the electric socket 140 of FIG. 1 is electrically connected to another electric plug 600 according to another embodiment of the present invention. In FIG. 5C, the electric plug 600 with six pins to match the electric socket 140 (shown in FIG. 5A) is provided. An external load 610 electrically connects the pins No. 5 and No. 2 of the electric plug 600, while the other pins are electrically connected as shown in FIG. 5B. Therefore, the two cell sections 400 can be electrically connected to each other in parallel to supply 14V nominal voltage, when the electric plug 600 is inserted into the electric socket 140.

Besides, the fan 150 supplies reaction air and cooling air for the primary zinc air battery 100. The primary zinc air battery 100 may include means for activating the fan 150 only when the primary zinc air battery is electrically connected to an external load, i.e. the electric plug 500 or 600 is inserted into the electric socket 140. Reference is made to FIG. 5A-5C. The fan 150 may electrically connect the receptors No. 3 and No. 6 of the electric socket 140. The fan 150 will be activated by one of the cell section 400, when the electric plug 500 or 600 is inserted to the electric socket 140. The receptor No. 3 of the electric socket 140 will be connected to receptor No. 1, and the receptor No. 6 will be connected to receptor No. 4 through wiring conductors, for example, copper wires inside the electric plugs 500 or 600. Therefore, the fan 150 is activated when the electric plug 500 (shown in FIG. 5B) or the electric plug 600 (shown in FIG. 5C) is inserted into the electric socket 140.

Many military electronic devices require 6-30V DC operating voltage, and this operating voltage may be provided by a battery which meets the requirement of the MIL-PRF-49471(CR) military specification. For example, a lithium-sulfur dioxide battery, such as a BA-5590/U military battery, or a lithium manganese dioxide battery, such as a BA-5390/U military battery, may be suitable for supplying 15V DC or 30V DC to a military electronic device. Therefore, the case 110 shown in FIG. 1 may have dimensions of 5″×4.4″×2.45″ to satisfy the requirement of the MIL-PRF-49471(CR) military specification. Furthermore, the location and the type of the electric socket 140 shown in FIG. 1 may meet the requirement of the MIL-PRF-49471(CR) military specification as well.

The capacity of the primary zinc air battery 100 can be up to 18 Ah at 28 V mode, and the total energy content of the primary zinc air battery 100 could be more than 500 Watt-hours. Besides, this primary zinc air battery 100 may deliver 4 A of maximum current to satisfy almost all military radio sets. The difference between the primary zinc air battery 100 and the BA-5590/U military battery is that both the energy capacity and power of the primary zinc air battery 100 are doubled compared to the BA-5590/U, even with the same specified dimensions.

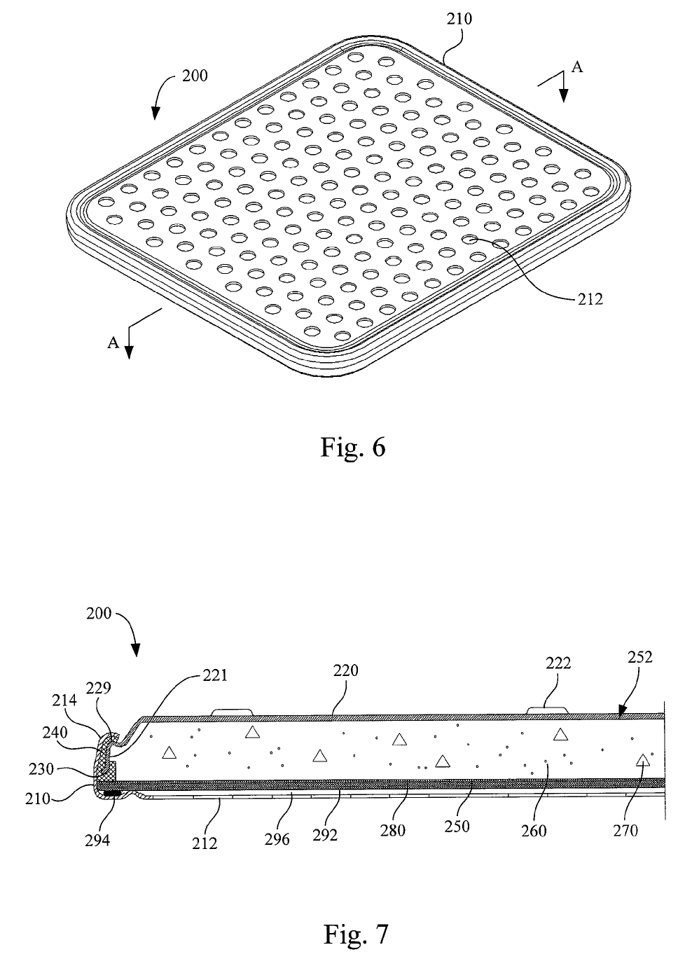

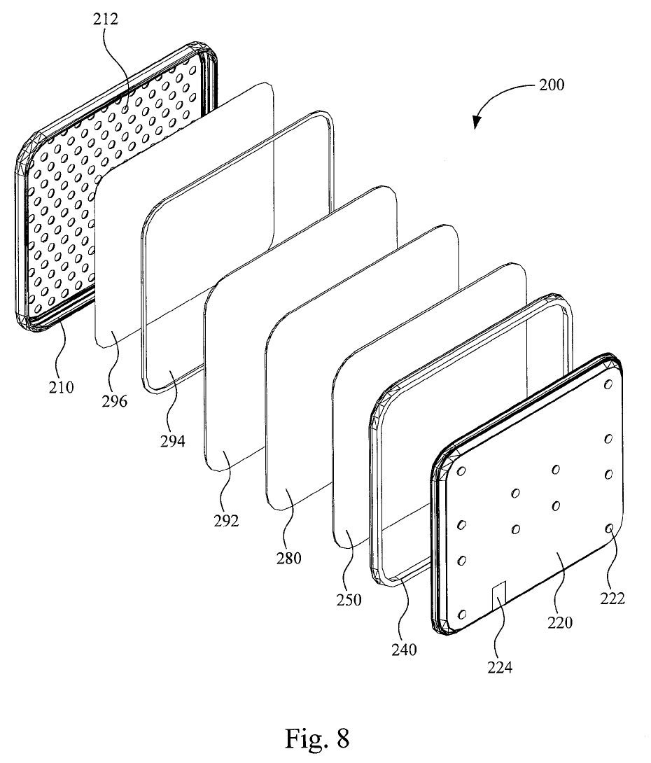

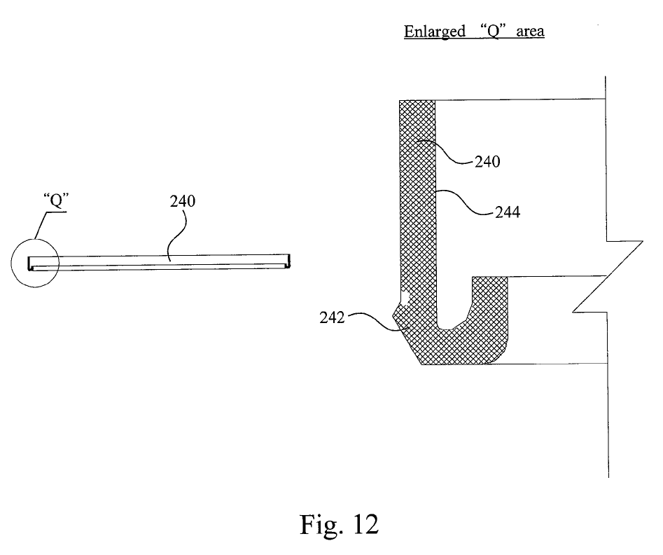

Reference is made to FIGS. 6-8. FIG. 6 is a perspective view showing one of the primary zinc air cells 200 shown in FIG. 2, FIG. 7 is a partial sectional view along line A-A shown in FIG. 6, and FIG. 8 is an exploded view of the primary zinc air cell 200 shown in FIG. 6. The primary zinc air cell 200 includes a cover 210, a sheet of liquid-absorb paper 296, a sheet of blocking layer 292, an air cathode 280, a sheet of separator 250, a zinc paste and a tray 220 arranged subsequently one after another. Besides, a gasket 294 is sandwiched between the cover 210 and the periphery of the blocking layer 292; still a sealing member 240 is covered on the lip 230 of the tray 220 to insulate the cover 210 and the tray 220; besides, a compressible sealing extrusion 242 (as shown in FIG. 12) on the periphery of the sealing member 240 is tightly sandwiched between the lower portion of the inner surface of the wall 214 of the cover 210 and the edge of the lip 230 of the tray 220. The cover 210 has a plurality of air inlet holes 212 disposed thereon. The tray 220 is coupled with the cover 210. The lip 230 extends outwards from the wall 221 of the tray 220. The separator 250 is positioned immediately after the air cathode 280 to prevent the short circuit of the air cathode 280, and the zinc paste is filled in the cavity 252 of the tray 220.

It is well known to public, that the zinc paste is a mixture of zinc particles 270, adhesive, hydrogen inhibitor and electrolyte 260, which is a potassium hydroxide solution.

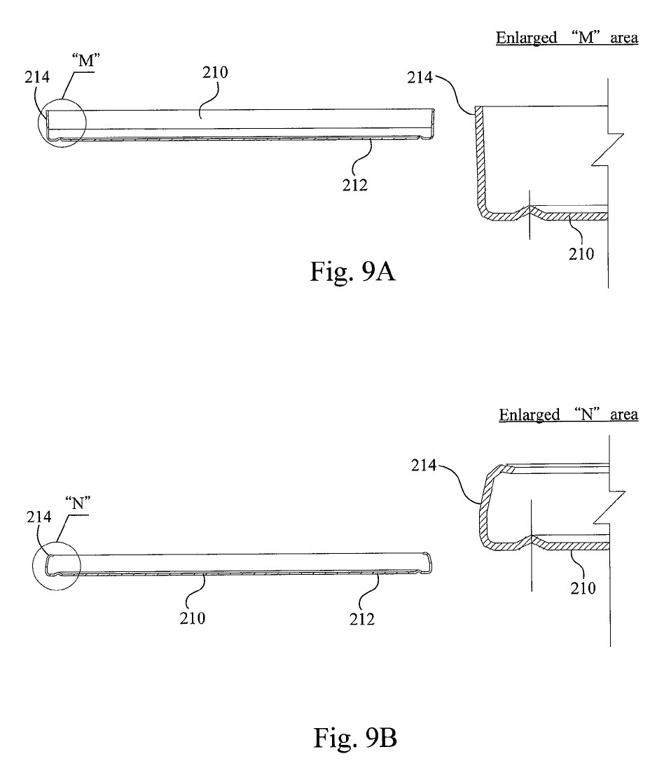

Reference is made to FIGS. 9A and 9B. FIGS. 9A and 9B are sectional views of the cover 210 shown in FIG. 8 before and after installation. The cover 210 may be a punched part made of nickel-plated carbon steel sheet or stainless steel sheet, and the thickness of the cover 210 may be about 0.25-0.3 mm. The wall 214 of the cover 210 extends a little bit outwards before installation (shown in the enlarged “M” area in FIG. 9A) for easy insertion of the matching parts, for example the tray 220 shown in FIG. 8. Eventually, the wall 214 of the cover 210 is pressed inwards (as shown in FIG. 9B) after installation to seal the primary zinc air cell 200 (shown in FIGS. 6-8).

Reference is made to FIG. 8. As maximum output power is desired from the primary zinc air cell 200, the air cathode 280 may be exposed to air as much as possible. Hence, the size and number of the air inlet holes 212 are enlarged to maximum, as long as the cover 210 still has enough rigidity, for example, as many holes as possible to arrange the 2 mm diameter holes with about 4-5 mm apart between the centers of the holes.

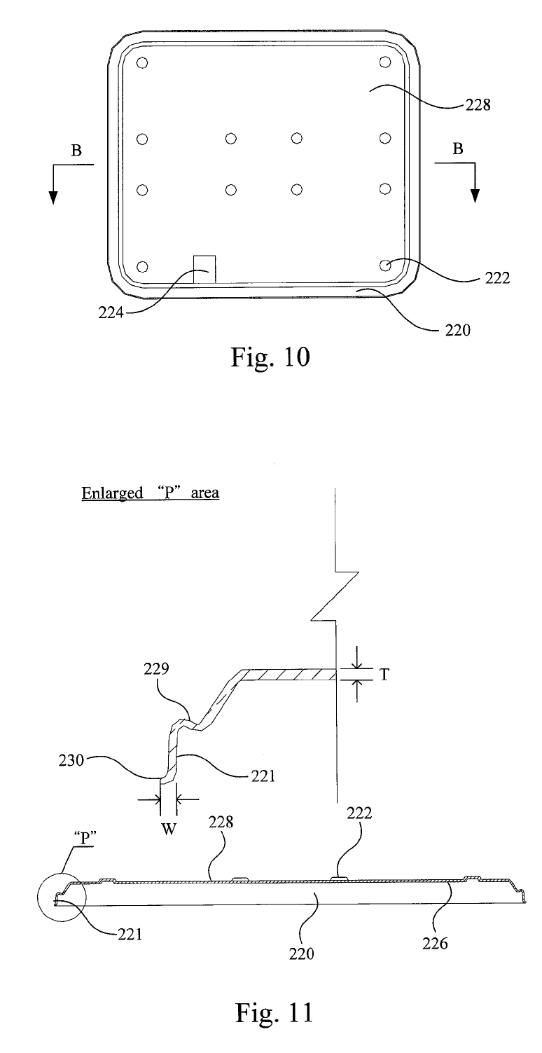

Reference is made to FIGS. 10-11. FIG. 10 is a bottom view of the tray 220 shown in FIG. 8, and FIG. 11 is a sectional view along line B-B shown in FIG. 10. The tray 220 may be made of carbon steel, and the thickness of the tray 220 may be about 0.25-0.3 mm. Furthermore, the outer surface 228 of the tray 220 may be nickel-plated, and the inner surface 226 of the tray 220 may be plated with copper and indium subsequently. Moreover, many other commercial plated-ready metal sheets may also be used to make the tray 220.

As shown in FIGS. 10-11, the tray 220 may have at least one spot 222 extruded from the outer surface 228 of the tray 220. The diameter of the spot 222 may be about 2 mm, and the height of the spot 222 may be about 0.25-0.5 mm. The spot 222 is used as an electric contact while the primary zinc air cell 200 (shown in FIGS. 6-8) is electrically connected to another primary zinc air cell 200 (shown in FIGS. 6-8) in series. In addition, owing to the spot 222, there can be an air passage positioned between those two primary zinc air cells 200 (shown in FIGS. 6-8). Besides, a sunken area 224 may also be prefabricated on the outer surface 228 of the tray 220 in case a metal connecting piece could be soldered on.

Reference is made to FIG. 11. A part of the wall 221 of the tray 220 is bent outwards to form the lip 230. The width W of the lip 230 is about twice of the thickness T of the tray 220. With the same clamping force, the widened lip 230 can prevent the sealing member 240 shown in FIG. 7 from being cut by the sharp edge of the un-widen wall 221 of the tray 220, when the tray 220 is clamped with the cover 210.

Reference is made to FIGS. 7 and 12. FIG. 12 is a sectional view of the sealing member 240. As the tray 220 is a thin metal punched part, the surface 229 of the tray 220 may be deformed downwards when the tray 220 is clamped with the cover 210. This may result in the leakage of the electrolyte 260. To solve this problem, the sealing member 240 may have a compressible sealing extrusion 242. The compressible sealing extrusion 242 of the sealing member 240 should be aligned with the lip 230. While the sealing member 240 and the tray 220 are clamped with the cover 210, the compressible sealing extrusion 242 of the sealing member 240 is deformed to cram any possible gap between the cover 210 and tray 220, e.g. a capillary channel happened between the inner surface of the cover 210 and the sealing member 240 as well as another capillary channel happened between the sealing member 240 and the outer surface of the lip 230, and thus the leakage of the electrolyte 260 is eliminated.

The sealing member 240 shown in FIG. 12 may be made of Nylon or polypropylene. Furthermore, the inner surface 244 of the sealing member 240 may be bent by the cover to touch the surface 229 of the tray 210 shown in the enlarged “P” area of the FIG. 11.

Reference is made to FIGS. 7-8. The primary zinc air cell 200 may further include the gasket 294 between the peripheries of the blocking layer 292 and the cover 210. This gasket 294 may be made of any alkaline-resist rubber, such as butyl rubber.

The blocking layer 292 shown in FIG. 7 may be a polytetrafluoroethylene (PTFE) membrane, for example a two-dimensional stretched PTFE membrane. This PTFE membrane is an air permeable and liquid impermeable membrane to prevent the leakage of the electrolyte 260. The thickness of the PTFE membrane may be about 0.02-0.1 mm in this embodiment, and more particularly the thickness of the PTFE membrane may be about 0.04-0.07 mm.

The primary zinc air cell 200 shown in FIG. 7 may further include the sheet of liquid-absorb paper 296, slightly less than the size of the air cathode 280, positioned between the cover 210 and the blocking layer 292. This liquid-absorb paper 296 can absorb the possible leaked electrolyte after the primary zinc air cell 200 is discharged. The thickness of the liquid-absorb paper 296 may be about 0.15-1 mm in this embodiment, and more particularly the thickness of the liquid-absorb paper 296 may be about 0.3-0.5 mm.

The air cathode 280 shown in FIG. 7 may have low polarization voltage. For example, the air cathode provided by Powerzinc Electric, Inc. (CA) is suitable for this embodiment.

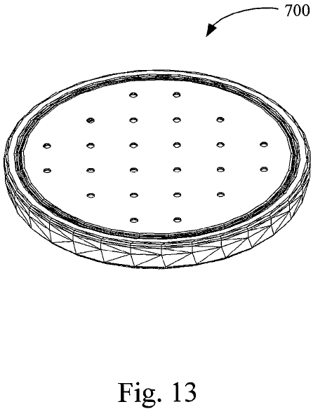

Although the present invention has been described in considerable detail with reference to certain embodiments thereof, other embodiments are possible. For example, the primary zinc air cell 700 according to another embodiment may be round as shown in FIG. 13. Therefore, their spirit and scope of the appended claims should no be limited to the description of the embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A primary zinc air battery, comprising:
a case;
an air inlet disposed on the case;
an air outlet disposed on the case;
a plurality of primary zinc air cells disposed in the case and electrically connected to each other;
an electric socket disposed on the case and electrically connected to the primary zinc air cells; and
a fan disposed in the case.

2. The primary zinc air battery of claim 1, wherein the primary zinc air cells are divided into at least two cell sections, and the cell sections are electrically connected to each other in series or in parallel.

3. The primary zinc air battery of claim 2, wherein each of the cell sections is divided into at least two cell sub-groups, and the cell sub-groups are electrically connected to each other in parallel.

4. The primary zinc air battery of claim 3, wherein each of the cell sub-groups has parts of the primary zinc air cells electrically connected to each other in series.

5. The primary zinc air battery of claim 1, wherein the case has dimensions of 5″×4.4″×2.45″.

6. The primary zinc air battery of claim 1, further comprising two plastic plugs respectively inserted into the air inlet and the air outlet before use.

7. The primary zinc air battery of claim 1, further comprising means for activating the fan when the primary zinc air battery is electrically connected to an external load.

8. The primary zinc air battery of claim 1, further comprising at least one sheet of liquid-absorb paper disposed on the inner surface of the case to prevent possible leaked electrolyte to the outside of the case of the primary zinc air battery after discharge.

9. The primary zinc air battery of claim 1, wherein each of the primary zinc air cells comprises:
a cover having a plurality of air inlet holes disposed thereon;
a tray coupled with the cover;
a lip extending outwards from the wall of the tray;
a sealing member sandwiched between the cover and the tray;
a separator positioned between the cover and the tray for forming a cavity between the separator and the tray;
a zinc paste filled with the cavity;
an air cathode positioned between the separator and the cover;
a blocking layer positioned between the air cathode and the cover;
a gasket positioned between the periphery of the blocking layer and the cover; and
a piece of liquid-absorb paper, less than the size of the air cathode, positioned between the blocking layer and the cover.

10. The primary zinc air battery of claim 9, wherein the width of the lip is about twice of the thickness of the tray.

11. The primary zinc air battery of claim 9, wherein the each of the primary zinc air cells further comprises a compressible sealing extrusion on the periphery of the sealing member sandwiched between the lower portion of the wall of the cover and the edge of the lip to avoid leak of electrolyte through a capillary channel happened between the inner surface of the cover and the sealing member as well as another capillary channel happened between the sealing member and the outer surface of the lip.

12. The primary zinc air battery of claim 9, wherein the tray has at least one spot extruded from the outer surface of the tray.

13. The primary zinc air battery of claim 9, wherein the blocking layer comprises a polytetrafluoroethylene (PTFE) membrane.

14. The primary zinc air battery of claim 1, wherein each of the primary zinc air cells is rectangular or round.

15. A primary zinc air cell, comprising:
a cover having a plurality of air inlet holes disposed thereon;
a tray coupled with the cover;
a lip extending outwards from the wall of the tray;
a sealing member sandwiched between the cover and the tray;
a separator positioned between the cover and the tray for forming a cavity between the separator and the tray;
a zinc paste filled with the cavity;
an air cathode positioned between the separator and the cover;
a blocking layer positioned between the air cathode and the cover;
a gasket positioned between the periphery of the blocking layer and the cover; and
a piece of liquid-absorb paper, less than the size of the air cathode, positioned between the blocking layer and the cover.

16. The primary zinc air cell of claim 15, wherein the width of the lip is about twice of the thickness of the tray.

17. The primary zinc air cell of claim 15, further comprising a compressible sealing extrusion on the periphery of the sealing member sandwiched between the lower portion of the wall of the cover and the edge of the lip to avoid leak of electrolyte through a capillary channel happened between the inner surface of the cover and the sealing member as well as another capillary channel happened between the sealing member and the outer surface of the lip.

18. The primary zinc air cell of claim 15, wherein the tray has at least one spot extruded from the outer surface of the tray.

19. The primary zinc air cell of claim 15, wherein the blocking layer comprises a polytetrafluoroethylene (PTFE) membrane.

20. The primary zinc air cell of claim 15, wherein the primary zinc air cell is rectangular or round.
